(19) United States
(12) Patent Application Publication
(10) Pub. No.: US 2014/0239815 A1
(43) Pub. Date: Aug. 28, 2014

(54) METHOD AND SYSTEM FOR CONTROLLING LIGHTING OPERATION

(71) Applicant: Power One Data International, Inc., Mesa, AZ (US)

(72) Inventors: Michael McGOWAN, Phoenix, AZ (US); Sameer PATIL, Bangalore (IN); Mahesh H. KALAIAH, Bangalore (IN)

(73) Assignee: Power One Data International, Inc., Mesa, AZ (US)

(21) Appl. No.: 13/960,303

(22) Filed: Aug. 6, 2013

(30) Foreign Application Priority Data
Feb. 28, 2013 (IN) 876/CHE/2013

(51) Int. Cl. H05B 37/02

(52) U.S. Cl. CPC H05B 37/02; H05B 37/0209
USPC 315/130; 315/294

(57) ABSTRACT

The invention provides a method and system for controlling a streetlight lighting operation. The system includes a plurality of streetlights, pole controllers associated with one or more streetlights and segment controller for a set of streetlights. The segment controller is configured to generate control signals based on control criterion that are translated as commands to the pole controllers to operate the streetlights. The operation of streetlights includes switching on, switching off or dimming of the streetlights. The method described herein also includes receiving feedback from the pole controllers that is useful for monitoring and maintenance operations.

### CROSS-REFERENCE TO RELATED APPLICATIONS

This application claims priority to Indian Patent Application Serial No. 876/CHE/2013 filed Feb. 28, 2013, the content of which is incorporated herein by reference in its entirety.

### FIELD OF THE INVENTION

This invention pertains to lighting operation in general, and to methods and systems for controlling streetlight operation in particular that enables efficient lighting operation and reduces power wastage.

### BACKGROUND OF THE INVENTION

Streetlights are a necessary feature for any road transport related infrastructure in any organized dwelling such as a city. Very often, the lighting operation of streetlights is either manual or pre-set for a fixed time and duration of the day. Such operation leaves scope of improper management of streetlight operation that is commonly observed when the streetlights are left on during bright morning hours or are not switched on during evening and night periods. These problems arise in case of manual operation, either due to the absence of the operator, or indiscipline at the operator end.

In case of streetlights that are pre-set for switch-on and switch off sometimes the timer circuit does not work appropriately and unless routine maintenance operation is performed or unless a complaint is registered, such faulty timer circuits are not fixed and for several days at a stretch the lighting operation is affected. Further, the pre-set times do not account for any immediate ambient conditions, such as seasonal variations in sunrise and sunset times, or emergence of weather patterns that may be predicted ahead of time. These issues are a major source of revenue drain for the state and country administration and if not properly maintained, can result in lot of inconvenience to the citizens. Also, streetlights, if left switched on for long times, can adversely impact the environment.

### OBJECTS OF THE INVENTION

Current streetlight operation is sub-optimal due to the reasons stated hereinabove. It is an object of the invention to provide a centralized streetlight management method and system to enable proper control and functioning of the streetlights based on dynamic lighting requirements.

### BRIEF SUMMARY OF THE INVENTION

In one aspect, the invention provides a method for controlling a streetlight lighting operation. The method comprises steps for providing streetlights; generating a control signal for controlling streetlight operation for at least one streetlight by a segment controller, based on one or more of control criterion; transmitting the control signal to a pole controller associated with each streetlight and operating the streetlight based on the respective control signal.

In another aspect, the invention provides a system for controlling streetlight lighting operation. The system comprises a set of streetlights; a segment controller configured to transmit control signals for controlling operation of each streetlight within the set of streetlights; and a pole controller for receiving a command representative of the control signal to operate one or more streetlights in the set of streetlights.

### BRIEF DESCRIPTION OF THE SEVERAL VIEWS OF THE DRAWINGS

These and other features, aspects, and advantages of the present invention will become better understood when the following detailed description is read with reference to the accompanying drawings in which like reference numerals represent corresponding parts throughout the drawings, wherein:

FIG. 1 is a diagrammatic representation of a streetlight control system for managing streetlight operation;

FIG. 2 is a flowchart representation of a method for controlling the streetlight operation in accordance with one aspect of the invention; and

FIG. 3 is as flowchart representation of a method of FIG. 2 additionally including a feedback from each streetlight for maintenance and audit purpose.

### DETAILED DESCRIPTION OF THE INVENTION

As used herein and in the claims, the singular forms “a,” “an,” and “the” include the plural reference unless the context clearly indicates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

The invention provides a system and method for managing and controlling streetlight operation in an efficient manner that leads to optimal use of the lighting infrastructure and reduces power/energy wastage.

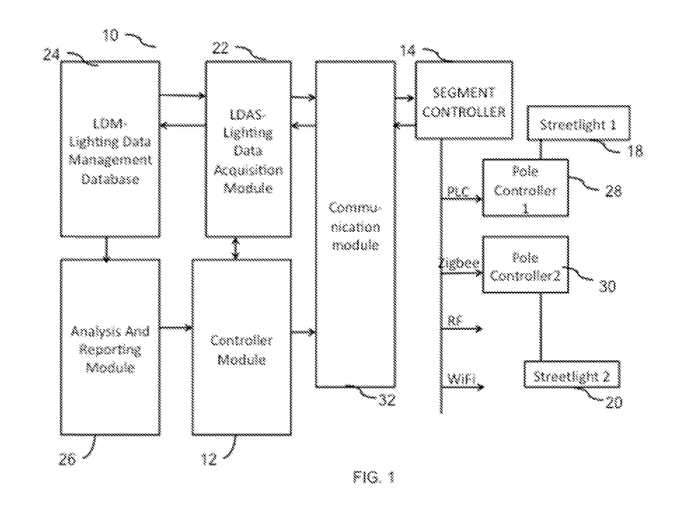

In one embodiment, as shown in FIG. 1, a system for controlling streetlight operation is shown as system 10. The system 10 includes a controller module 12 that is configured to control streetlights 18, 20. For this control purpose, the controller module includes one or more segment controllers 14. Each segment controller is associated with at least a set of streetlights. For example segment controller 14 is associated with a set or network of streetlights 18, 20. Similarly, another segment controller (not shown in FIG. 1) may be associated with a different set or network of streetlights. In this exemplary embodiment, the system is shown to comprise two streetlights that are controlled by one controller module for illustration purposes, however, one skilled in the art would be able to extend this to any number of streetlights controlled by any number of controller module in a facile manner. It would be appreciated by those skilled in the art that these segment controllers advantageously enable very efficient control for streetlights that can be centrally planned and lighting operation executed locally for different sets of streetlights in a pre-defined region or area.

The controller module 12 is coupled to a lighting data acquisition module 22, which in turn is coupled to a lighting data management database 24 that receives and then provides to the controller module 12 lighting data such as current ambient natural light, historic natural light data, weather information, lighting requirements of different regions and other such data useful for planning the lighting operation. The controller module 12 is also coupled to an analysis and reporting module 26 for providing analytics useful for planning the lighting operation. The controller module uses the inputs from the database 24, and analytics and reporting module 26 to generate control criterion that the segment controller such as 14 uses to control the lighting operation of streetlights 18 and 20. The control criterion in one exemplary implementation include a threshold light-on limit, beyond which the streetlights are activated to switch on and a threshold light-off limit, beyond which the streetlights are switched off. These threshold limits are dynamically monitored and changed based on historic data and current weather conditions. It would be appreciated by those skilled in the art that the switching time for each streetlight or a network of streetlights can be planned and programmed on daily/monthly/yearly basis. The programming can be set as per change in nightfall schedule throughout the year.

In the exemplary embodiment, the segment controller 14 communicates to each respective pole controller 28, 30 for controlling the streetlights 18 and 20 respectively. In another embodiment each respective pole controller may be associated with more than one streetlight. The pole controllers are configured to communicate with the associated streetlight/streetlights through a hardware implementation or through wireless communication. A communication module 32 incorporating a communication interface is used in system 10 for transmitting the control signals from the segment controller 14 to pole controllers 28, 30. Additionally an extraneous hardware such as a data concentrator unit (not shown in FIG. 1) may be used to receive the control signals from the segment controller via the communication module, and translate the control signals into specific commands for each pole controller. Alternately, the functioning of the data concentrator unit may be integrated with the segment controller itself. The specific commands to the pole controllers may include commands for switching on or off for each streetlight. Commands may also include activating a dimming operation in the streetlight for power saving. The communication between the different modules and pole controllers may be through a dedicated communication platform or through other communication means such as radio frequency means, infra red means, zigbee, wifi, Bluetooth, PLCs (Programmable Logic Controllers), PSTN (Public Switched Telephone Network), or through GPRS (General Packet Radio Service) and the like, and combinations thereof.

The pole controllers 28, 30 in one embodiment are advantageously capable of two way communication as is explained in more detail hereinafter. The pole controllers include microcontrollers and registers for enabling the two-way communication. The pole controllers may also include latch relays to respond to triggers and signals from the controller module as described herein above.

The pole controllers 28 and 30 further are configured to provide feedback referred herein as pole data to the segment controller 14 or to the lighting data acquisition module 22. The pole data includes data representative of health of the pole controller, health of the streetlight, that is translated into operative parameters for each streetlight by the segment controller 14 or the lighting data acquisition module 22. These operative parameters are transmitted to the lighting management database 24 and further to the analysis and reporting module 26 and using these operative parameters for conducting different analytics and reports that are useful in maintenance and audit functions of the pole controllers and streetlights. Output from the analytics and reporting module 26 may be in the form of alerts for maintenance, commands for the controller module, or in the form of reports displayed on other display device useful for monitoring the streetlight operation. The reports may be related for example to energy consumption analytics for each or set of streetlights, and used for planning the power distribution. The exemplary analytics and reports may also relate to the burning hours of streetlights which can be computed with good certainty and maintenance/replacement can be planned accordingly. The alerts may he communicated as short messaging service (SMS) to a concerned authority or another controller on occurrence of any programmed event or faults with exact time stamping as well. It would also be appreciated by those skilled in the art that the analysis and reporting module may send the different analytics reports to a display device or a host or a central computer or such communication device that can be accessed by a user, manager, administrator for viewing and for further planning and decision making.

Thus the system 10 provides real time monitoring and control of the lighting operation of streetlights. Aspects of system 10 are implemented in one example via API's (application protocol interfaces). Aspects of the system 10 may also be web enabled allowing access via Internet. The system 10 in an exemplary implementation may also include a cloud storage module for storing the lighting data management database and the data from the segment controller or a data concentrator unit.

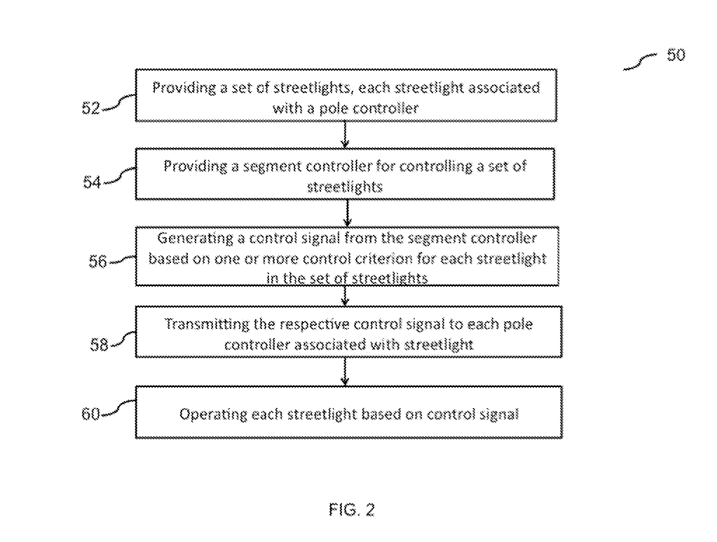

The invention also provides an exemplary method for controlling a streetlight operation as shown in the flowchart 50 in FIG. 2 and that is used by system 10 of FIG. 1. The method includes steps 52 and 54 that provide a set of streetlights, each streetlight associated with a pole controller, and for providing segment controllers associated with a set or network of pole controllers for controlling the streetlight operation. For controlling the streetlight operation, a control signal is generated as shown at step 56 by the segment controller. The control signal is based on one or more control criterion for each streetlight in the set of streetlights segment controllers as explained in reference with system 10. Step 58 involves transmitting the respective control signal to each pole controller associated with streetlight. And at step 60 each streetlight is operated based on control signal. The operation of streetlight may include a switching on or switching off or dimming operation.

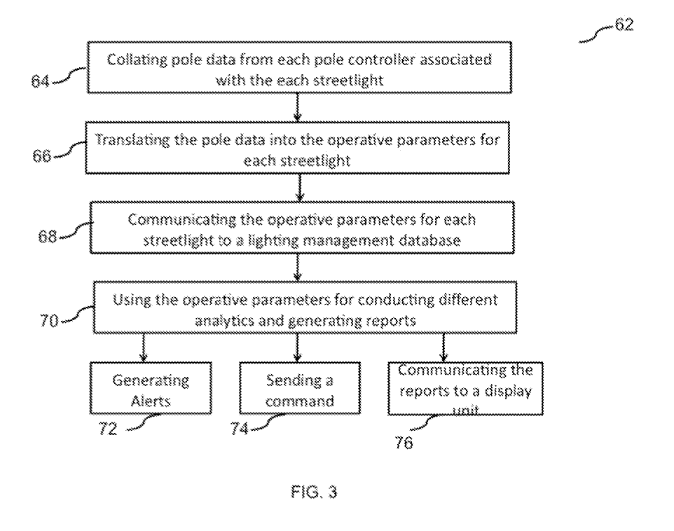

FIG. 3 is a flowchart 62 that has further method steps that relate to communication from the pole controllers that is useful in monitoring, and maintenance and further control functions. The method step 64 involves collating pole data from each pole controller associated with each or set of streetlights. The method step 66 involves translating the pole data into the operative parameters for each streetlight. The operative parameters may be related to energy consumption, burn rates, or other equipment/component health parameters. The method step 68 involves communicating these operative parameters for each streetlight to a lighting management database. The database is useful for seeing trends, recurring patterns and fault conditions. The method step 70 involves using the operative parameters for generating different analytics and reports that are further used for generating alerts as shown by reference numeral 72, sending commands 74, communicating reports to another display device, as indicated by reference numeral 76. The alerts and commands may be sent as audio alarms or visual alarms or through email or other text messages using SMS to other devices.

It would be appreciated by those skilled in the art that the exemplary embodiments describe control and monitoring of lighting operation for streetlights, as a non-limiting example of lighting operation. The system 10 and the methods described herein are similarly applicable to other lighting operations such as common lighting in apartments and commercial buildings, community buildings and areas, parking lights, and the like.

It would be appreciated by those skilled in the art that the aspects of the invention as described herein provide several advantages that include efficient management of lighting operation and power saving. The switching on/off of the streetlights can now be remotely planned, re-planned and executed as per the dynamic needs and requirements. Intelligent interface devices can be implemented through the system that can optimize the energy requirements by recording the changes in nightfall in different seasons. The system described herein utilizes communication techniques such as through the power line carrier, or wireless modes etc. and offers real time surveillance of individual group of junction boxes and lamps in the streetlights, this greatly enhances savings in operating costs. The two way communication ability of the pole controllers allows collection of precise and accurate information on electricity consumption, helps to plan preventive maintenance, and reduces maintenance cost per pole. Another advantage of the system and methods described herein is the scalability of the system as any number of new streetlights can be added to the existing network with simple and easy modifications. Other such advantages will become apparent to those skilled in the art.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A method for controlling a streetlight lighting operation, the method comprising:
providing a plurality of streetlights;
generating a control signal for controlling streetlight operation for each of the plurality of streetlights by a segment controller, based on one or more of control criterion:
transmitting the control signal to a pole controller associated with at least one streetlight;
operating the at least one streetlight based on the control signal.

2. The method of claim 1 wherein the one or more control criterion is a threshold light-on limit, and a threshold light-off limit.

3. The method of claim 1 wherein the operating is at least one of switching on, switching off or dimming of the at least one streetlight.

4. The method of claim 1 further comprising:
collating pole data from the pole controller associated with the at least one streetlight;
translating the pole data into the operative parameters for the at least one streetlight;
communicating the operative parameters to a lighting management database;
using the operative parameters for conducting analytics;
generating at least one of alerts, commands, and reports based on analytics; and
communicating the at least one of alerts, commands, and reports to a display unit.

5. The method of claim 1 Wherein the segment controller is associated with a set of streetlights.

6. The method of claim 1 wherein the pole controller is associated with one or more streetlights.

7. A system for controlling streetlight lighting operation, the system comprising:
a set of streetlights;
a segment controller configured to transmit control signals for controlling:
operation of each streetlight within the set of streetlights; and
a pole controller for receiving a command representative of the control signal to operate one or more streetlights in the set of streetlights.

8. The system of claim 7 wherein the segment controller is integrated in a controller module.

9. The system of claim 8 further comprising a lighting data acquisition module configured to receive lighting data representative of lighting conditions and requirements and pole data representative of data from the pole controller.

10. The system of claim 9 further comprising a lighting data management database to record and store lighting data and pole data.

11. The system of claim 9 further comprising a communication module to transmit control signals from the segment controller and pole data from the pole controller.

12. The system of claim 7 wherein the segment controller is configured for translating pole data to operative parameters for each streetlight.

13. The system of claim 8 further comprising an analysis and reporting module for conducting analytics and generating at least one of alerts, commands, and reports based on analytics.
